(19) United States
(12) Patent Application Publication
(10) Pub. No.: US 2022/0034591 A1
(43) Pub. Date: Feb. 3, 2022

(54) Liquid cooling device and projection device

(71) Applicant: Coretronic Corporation, Hsin-Chu (TW)

(72) Inventors: SHI-WEN LIN, Hsin-Chu (TW); PEI-RONG WU, Hsin-Chu (TW)

(21) Appl. No.: 17/384,808

(22) Filed: Jul. 26, 2021

(30) Foreign Application Priority Data
Jul. 31, 2020 (CN) 202010755744.X

(51) Int. Cl. F28D 1/053; G03B 21/16

(52) U.S. Cl. CPC F28D 1/05341; F28D 2021/0028; G03B 21/16

(57) ABSTRACT

A liquid cooling device includes a first liquid cooling row having a first inflow end and a first outflow end for liquid to flow in a first direction, a second liquid cooling row having a second inflow end and a second outflow end, and a fan. The second liquid cooling row is disposed opposite to the first liquid cooling row. The second inflow end is connected to the first outflow end for the liquid flowing out from the first outflow end to flows in a second direction opposite to the first direction. Airflow generated by the fan sequentially flows through the second and first liquid cooling rows to cool the liquid. A projection device having the liquid cooling device is also provided.

### CROSS-REFERENCE TO RELATED APPLICATION

This application claims the priority benefit of China application CN202010755744.X, filed on Jul. 31, 2020. The entirety of the above-mentioned patent application is hereby incorporated by reference herein and made a part of this specification.

### FIELD OF THE INVENTION

The invention relates to a heat dissipating device, and more particularly to a liquid cooling device and a projection device using the same.

### BACKGROUND OF THE INVENTION

High level projection devices may use liquid cooling devices to cool components which have low thermal endurance, such as semiconductor light sources (for example, light-emitting diodes or laser diodes) and digital micromirror devices (DMD).

FIG. 1A is a schematic diagram of a liquid cooling device of the prior art. Please refer to FIG. 1A, the liquid cooling device in the prior art includes a fan (not shown) and a liquid cooling row LC. Liquid L in the liquid cooling row LC flows in one direction. The flow direction of an airflow F generated by the fan is perpendicular to the flow direction of the liquid L to dissipate the heat of the liquid cooling row LC. However, such a structure may have problem that the airflow F absorbs the heat unevenly. Please refer to FIG. 1B, which is a schematic diagram of the temperature change before and after the airflow F of the liquid cooling device of FIG. 1A flowing through the liquid cooling row LC. In FIG. 1B, W1 on the horizontal axis corresponds to a position W1 in FIG. 1A where the liquid L flows into the liquid cooling row LC, and W2 corresponds to the position W2 in FIG. 1A where the liquid L flows out of the liquid cooling row LC. F1 is a temperature before the airflow F flows into the liquid cooling row LC. F2 is the temperature after the airflow F flows out of the liquid cooling row LC. The temperature difference between the temperature F2 and the temperature F1 at position W1 is ΔT1, and the temperature difference at position W2 is ΔT2. C is the temperature curve of the liquid L when it flows through the liquid cooling row LC. As shown in FIG. 1B, since the temperature curve C of the liquid L gradually decreases from the position W1 to the position W2, the temperature difference ΔT2 near the position W2 is obviously smaller than the temperature difference ΔT1 near the position W1. Thus, the heat absorbed by the airflow F flowing out of the position near the position W2 is much less than the heat absorbed by the airflow F flowing out of the position near the position W1. Therefore, the airflow F generated by the fan of the liquid cooling device in prior art has the disadvantage of uneven heat dissipation effect, and the overall heat dissipation effect of the liquid cooling device is limited. Since the heat dissipation effect is limited, the reliability of the projection device may also deteriorate.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a liquid cooling device which has good and even heat dissipation effect.

The invention provides a projection device which has good reliability.

Other advantages and objects of the invention may be further illustrated by the technical features broadly embodied and described as follows.

In order to achieve one or a portion of or all of the objects or other objects, an embodiment of the invention provides a liquid cooling device including a first liquid cooling row, a second liquid cooling row, and a fan. The first liquid cooling row has a first inflow end and a first outflow end for liquid to flow from the first inflow end to the first outflow end in a first direction. The second liquid cooling row is disposed opposite to the first liquid cooling row. The second liquid cooling row has a second inflow end and a second outflow end. The second inflow end is connected to the first outflow end for the liquid flowing out of the first outflow end to flows from the second inflow end to the second outflow end in a second direction, wherein the first direction is opposite to the second direction. The fan is adapted to generate airflow. The airflow sequentially flows through the second liquid cooling row and the first liquid cooling row to cool the liquid.

In order to achieve one or a portion of or all of the objects or other objects, an embodiment of the invention provides a projection device comprising an illumination system, a light valve, a projection lens, and a cooling system. The illumination system comprises a light source. The light source is adapted to provide an illumination beam. The light valve is disposed on a transmission path of the illumination beam to convert the illumination beam into an image beam. The projection lens is disposed on a transmission path of the image beam. The cooling system comprises the aforementioned liquid cooling device, at least one heat absorbing element, and a liquid conveying pipeline. The at least one heat absorbing element is connected to at least one of the light source and the light valve. The heat absorbing element has a liquid inflow end and a liquid outflow end. The liquid conveying pipeline is connected in series with the heat absorbing element and the liquid cooling device, wherein the liquid flowing out from the second outflow end flows into the heat absorbing element through the liquid conveying pipeline and the liquid inflow end and flows into the first inflow end through the liquid outflow end and the liquid conveying pipeline.

The liquid cooling device used in the invention has a first liquid cooling row and a second liquid cooling row disposed opposite to each other, wherein the liquid sequentially flows through the first liquid cooling row and the second liquid cooling row in two opposite directions, so the temperature of the liquid in the second liquid cooling row may be lower than the temperature of the liquid in the first liquid cooling row. Since the airflow generated by the fan sequentially cools the second liquid cooling row and the first liquid cooling row, the airflow of lower temperature is used to cool the second liquid cooling row of lower temperature when the airflow flows through the second liquid cooling row. The heated airflow which flowed through the second liquid cooling row is used to cool the first liquid cooling row of higher temperature. Thus, when the airflow flows through the second liquid cooling row and the first liquid cooling row, the airflow may maintain a proper temperature difference from the second liquid cooling row and the first liquid cooling row, respectively, thereby improving the heat exchange effect. In addition, the high temperature end (first inflow end) of the first liquid cooling row is adjacent to the low temperature end (second outflow end) of the second liquid cooling row, and the low temperature end (first outflow end) of the first liquid cooling row is adjacent to the high temperature end (second inflow end) of the second liquid cooling row. Therefore, part of the airflow after flowing through the low temperature end of the second liquid cooling row may flow through the high temperature end of the first liquid cooling row, and part of the airflow after flowing through the high temperature end of the second liquid cooling row may flow through the low temperature end of the first liquid cooling row. Such that the overall temperature of the airflow after sequentially flowing through the second liquid cooling row and the first liquid cooling row may be more even, thereby improving the overall heat dissipation effect of the airflow. Also, since the projection device of the invention uses the aforementioned liquid cooling device, the projection device has good reliability.

Other objectives, features and advantages of The invention will be further understood from the further technological features disclosed by the embodiments of The invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a liquid cooling device of the prior art;

FIG. 1B is a schematic diagram of the temperature change before and after the airflow of the liquid cooling device of FIG. 1A flowing through the liquid cooling row;

FIG. 2 is a schematic top view of a liquid cooling device according to an embodiment of the invention;

FIG. 3A is a schematic side view of the first liquid cooling row of FIG. 2;

FIG. 3B is a schematic side view of the second liquid cooling row of FIG. 2;

FIG. 4 is a schematic partial perspective view of the first liquid cooling row according to an embodiment of the invention;

FIG. 5 is a schematic enlarged diagram of area A in FIG. 2;

FIG. 6 is a schematic diagram of the temperature change before and after the airflow of the liquid cooling device flowing through the first liquid cooling row and the second liquid cooling row according to an embodiment of the invention; and

FIG. 7 is a schematic block diagram of a projection device according to an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

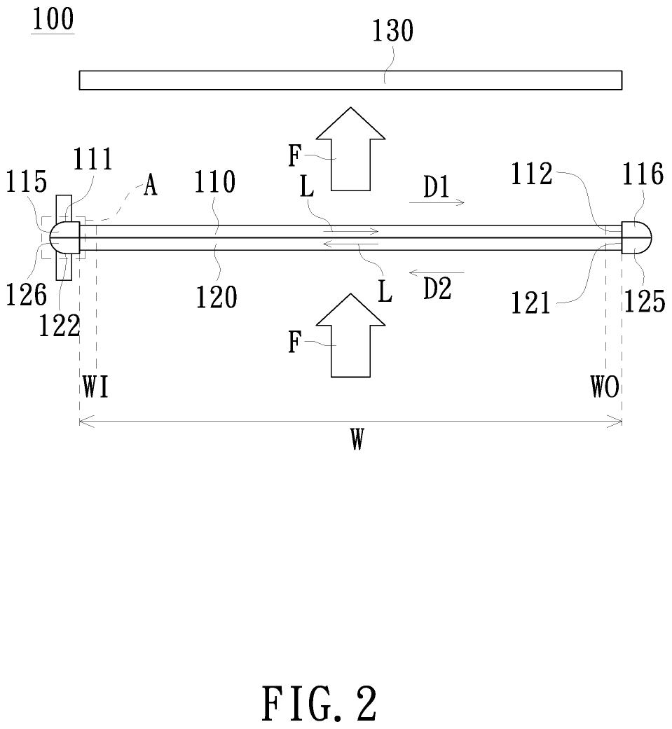

FIG. 2 is a schematic top view of a liquid cooling device according to an embodiment of the invention. Please refer to FIG. 2. A liquid cooling device 100 includes a first liquid cooling row 110, a second liquid cooling row 120 and a fan 130. The first liquid cooling row 110 has a first inflow end 111 and a first outflow end 112 for liquid L to flow from the first inflow end 111 to the first outflow end 112 in a first direction D1. The second liquid cooling row 120 is disposed opposite to the first liquid cooling row 110. The second liquid cooling row 120 has a second inflow end 121 and a second outflow end 122. The second inflow end 121 is connected to the first outflow end 112 for the liquid L flowing out of the first outflow end 112 to flow from the second inflow end 121 to the second outflow end 122 in a second direction D2, wherein the first direction D1 is opposite to the second direction D2. The fan 130 is adapted to generate airflow F. The airflow F sequentially flows through the second liquid cooling row 120 and the first liquid cooling row 110 to cool the liquid L.

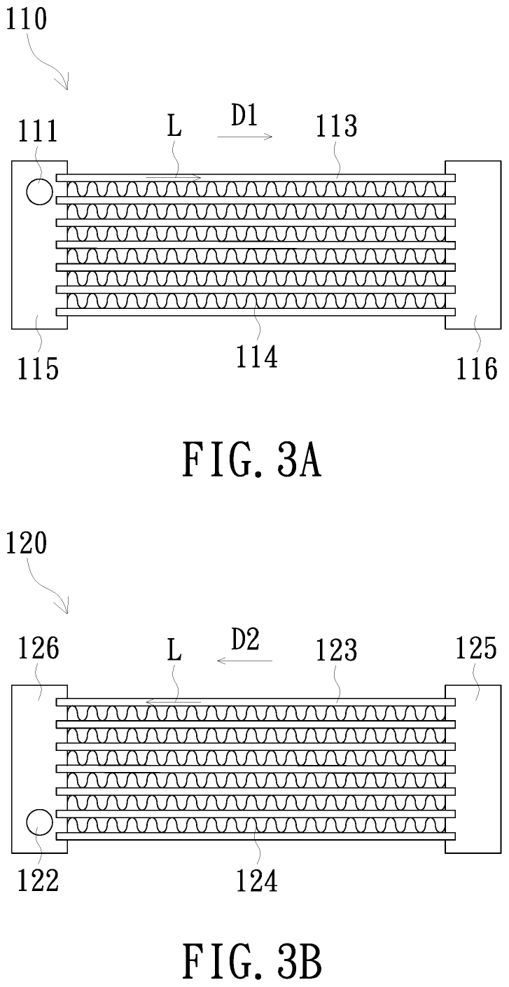

Each of the first liquid cooling row 110 and the second liquid cooling row 120 includes, for example, a plurality of liquid cooling tubes for conveying the liquid L. FIG. 3A is a schematic side view of the first liquid cooling row of FIG. 2. FIG. 3B is a schematic side view of the second liquid cooling row of FIG. 2. As shown in FIG. 3A, the first liquid cooling row 110 includes a plurality of first liquid cooling tubes 113 arranged at intervals. Each of the plurality of first liquid cooling tubes 113 extends in the first direction D1. As shown in FIG. 3B, the second liquid cooling row 120 includes a plurality of second liquid cooling tubes 123 arranged at intervals. Each of the plurality of second liquid cooling tubes 123 extends in the second direction D2. The plurality of first liquid cooling tubes 113 are respectively opposite to the plurality of second liquid cooling tubes 123. The liquid L flows through the plurality of first liquid cooling tubes 113 of the first liquid cooling row 110, and then flows through the plurality of second liquid cooling tubes 123 of the second liquid cooling row 120, so that waste heat may be dissipated from the first liquid cooling row 110 and the second liquid cooling row 120.

In addition, the first liquid cooling tubes 113 and the second liquid cooling tubes 123 may be connected to each other through a header tank. Please refer to FIG. 2 and FIG. 3A. The first liquid cooling row 110 may further include a first header tank 115 and a second header tank 116. The plurality of first liquid cooling tubes 113 are connected between the first header tank 115 and the second header tank 116. The first header tank 115 has the first inflow end 111. The second header tank 116 has the first outflow end 112. On the other hand, please refer to FIG. 2 and FIG. 3B. The second liquid cooling row 120 may further include a third header tank 125 and a fourth header tank 126. The plurality of second liquid cooling tubes 123 are connected between the third header tank 125 and the fourth header tank 126. The third header tank 125 has the second inflow end 121. The fourth header tank 126 has the second outflow end 122. With the aforementioned structure, the liquid L may enter the first header tank 115 from the first inflow end 111 first, and then enter the first liquid cooling tubes 113 from the first header tank 115. The liquid L flows in the first liquid cooling tubes 113 in the first direction D1 and flows into the second header tank 116 through the first outflow end 112. As shown in FIG. 2, the second header tank 116 and the third header tank 125 may be connected and communicated with each other, so that the liquid L may flow from the second header tank 116 into the third header tank 125. The liquid L flowed into the third header tank 125 flows into the second liquid cooling tubes 123 through the second inflow end 121 first, then flows in the second liquid cooling tubes 123 in the second direction D2, and then flows into the fourth header tank 126 through the second outflow end 122. In an embodiment, the first outflow end 112 and the second inflow end 121 may be connected to each other by a liquid conduit (not shown). For example, the liquid conduit is a water pipe, but it is not limited thereto. In another embodiment, the first outflow end 112 and the second inflow end 121 may also be produced in a manner of being integrally formed. In another embodiment, a quick release element (not shown) or other elements may also be provided between the first outflow end 112 and the second inflow end 121.

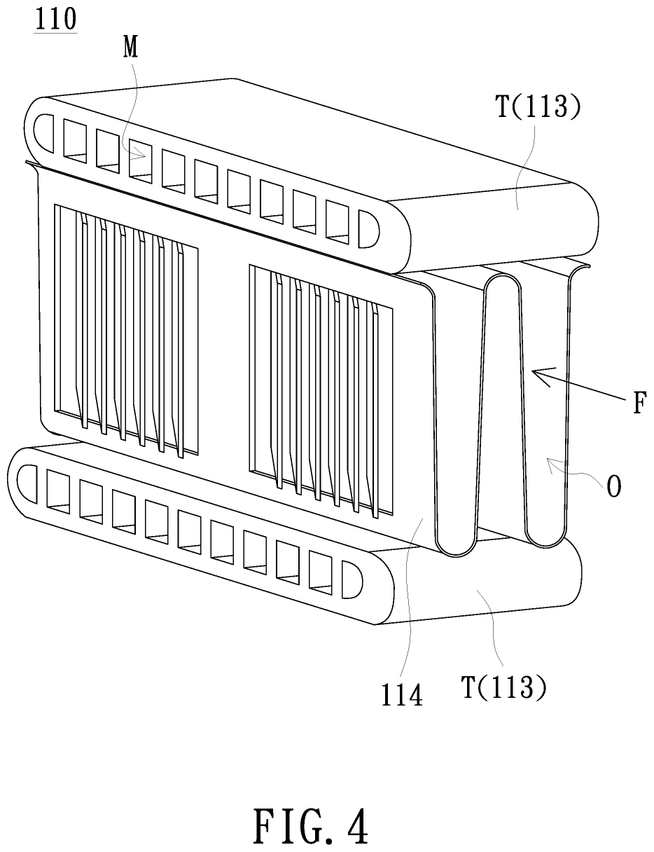

FIG. 4 is a schematic partial perspective view of the first liquid cooling row according to an embodiment of the invention. Only two first liquid cooling tubes 113 are shown in FIG. 4 for example. Please refer to FIG. 3A and FIG. 4. The first liquid cooling tubes 113 are flat tubes T for example. The inside of the flat tubes T are divided into a plurality of flowing spaces M for example, and the liquid L flows in these flowing spaces M. On the other hand, the second liquid cooling tubes 123 may also be the aforementioned flat tubes T although it is not shown in the drawings. Since the detailed features of the second liquid cooling tubes 123 are the same as those of the first liquid cooling tubes 113, no redundant description is given herein. It should be noted that the structures of the first liquid cooling tubes 113 and the second liquid cooling tubes 123 are only examples. The invention does not limit the specific structures of the first liquid cooling tubes 113 and the second liquid cooling tubes 123.

The first liquid cooling row 110 and the second liquid cooling row 120 may further include a heat dissipating element in order to enhance the heat dissipation effect of the first liquid cooling row 110 and the second liquid cooling row 120. Please refer to FIG. 3A and FIG. 3B again. The first liquid cooling row 110 may further include a plurality of first heat dissipating elements 114 connected between the first liquid cooling tubes 113. The second liquid cooling row 120 may further include a plurality of second heat dissipating elements 124 connected between the second liquid cooling tubes 123. In detail, please refer to FIG. 3A first and also refer to FIG. 4. Gaps O are formed between the first heat dissipating elements 114, so that the airflow F of the fan 130 may flow through the first heat dissipating elements 114 through the gaps O. In addition, the first heat dissipating elements 114 include a plurality of heat dissipating fins for example, and the heat dissipating fins are wave-shaped for example, but not limited thereto. The detailed features of the second heat dissipating elements 124 are the same as those of the first heat dissipating elements 114 shown in FIG. 4, so no redundant description is given herein.

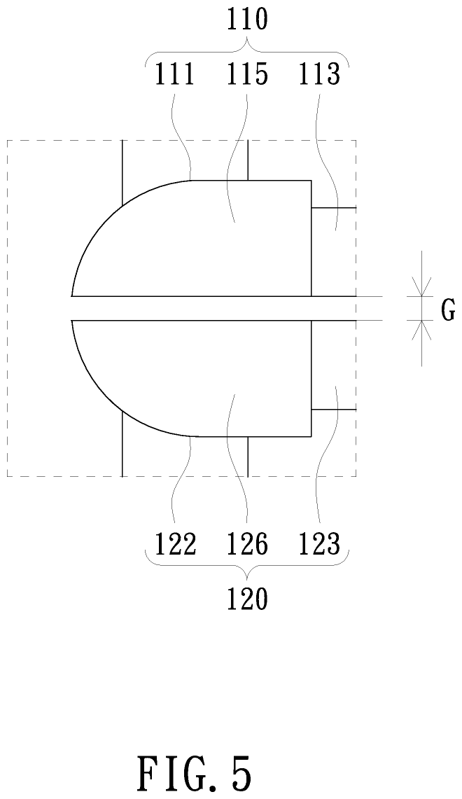

FIG. 5 is a schematic enlarged diagram of area A in FIG. 2. Please refer to FIG. 5. The first liquid cooling row 110 and the second liquid cooling row 120 are separated by a predetermined distance G Taking FIG. 5 as an example, the first liquid cooling tube 113 and the second liquid cooling tube 123 may be separated by the predetermined distance G, and the first header tank 115 and the fourth header tank 126 may also be separated by the predetermined distance G The temperature of the liquid L is higher when it flows through the first liquid cooling row 110, and the temperature is lower when it flows through the second liquid cooling row 120. Therefore, the predetermined distance G between the first liquid cooling row 110 and the second liquid cooling row 120 may prevent heat from being transferred from the first liquid cooling tube 113 to the second liquid cooling tube 123, so as to avoid increasing the temperature of the liquid L in the second liquid cooling row 120.

Please refer to FIG. 2 again. The airflow F generated by the fan 130 sequentially flows through the second liquid cooling row 120 and the first liquid cooling row 110. The fan 130 may be located on a side of the first liquid cooling row 110 away from the second liquid cooling row 120, and the airflow F generated by the fan 130 is a suction airflow. In another embodiment, the fan 130 may be located on a side of the second liquid cooling row 120 away from the first liquid cooling row 110, and the airflow F generated by the fan 130 is a blowing airflow. In another embodiment, the fan 130 may also be located in the predetermined distance G between the first liquid cooling row 110 and the second liquid cooling row 120. It may be understood that, generally, the more parts of the first liquid cooling row 110 and the second liquid cooling row 120 that the airflow F flows through, the better the heat dissipation effect of the liquid cooling device 100 is. Therefore, in the present embodiment, the airflow F generated by the fan 130 may flow through the entire first liquid cooling row 110 and the entire second liquid cooling row 120. Specifically, please refer to FIG. 3A and FIG. 4 again. The airflow F flows through all the gaps O between the first heat dissipating elements 114, for example, to absorb the waste heat of the first heat dissipating elements 114. On the other hand, in FIG. 3B, the airflow F also flows through all the gaps (not labeled) between the second heat dissipating elements 124 to absorb the waste heat on the second heat dissipating elements 124, thereby improving the heat dissipation effect. In addition, the number of the fan 130 may also be plural in order to make the airflow F flow through the entire first liquid cooling row 110 and the entire second liquid cooling row 120.

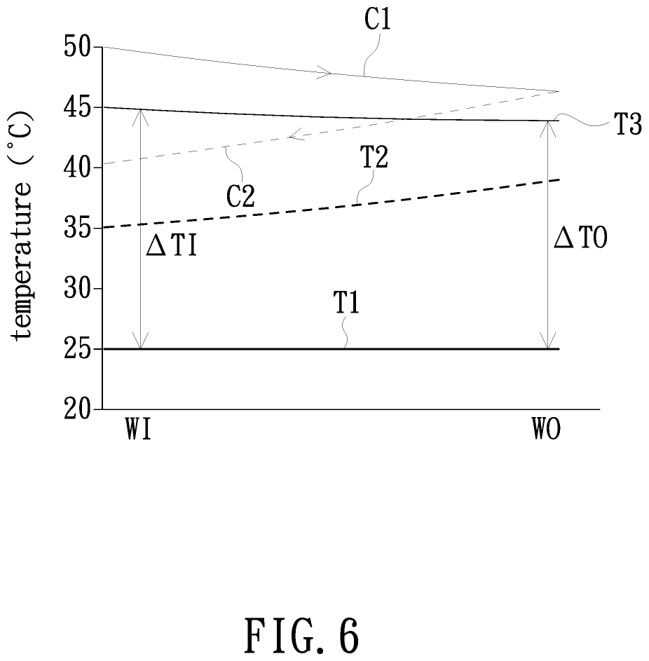

FIG. 6 is a schematic diagram of the temperature change before and after the airflow of the liquid cooling device flowing through the first liquid cooling row and the second liquid cooling row according to an embodiment of the invention. In FIG. 6, WI of the horizontal axis corresponds to the position where the liquid L flows into the first liquid cooling row 110 and flows out of the second liquid cooling row 120, and WO corresponds to the position where the liquid L flows out of the first liquid cooling row 110 and flows into the second liquid cooling row 120. In addition, T1 is the temperature of the airflow F before entering the second liquid cooling row 120. T2 is the temperature of the airflow F between the second liquid cooling row 120 and the first liquid cooling row 110. T3 is the temperature of the airflow F after flowing out of the first liquid cooling row 110. C1 is the temperature of liquid L in the first liquid cooling row 110. C2 is the temperature of liquid L in the second liquid cooling row 120.

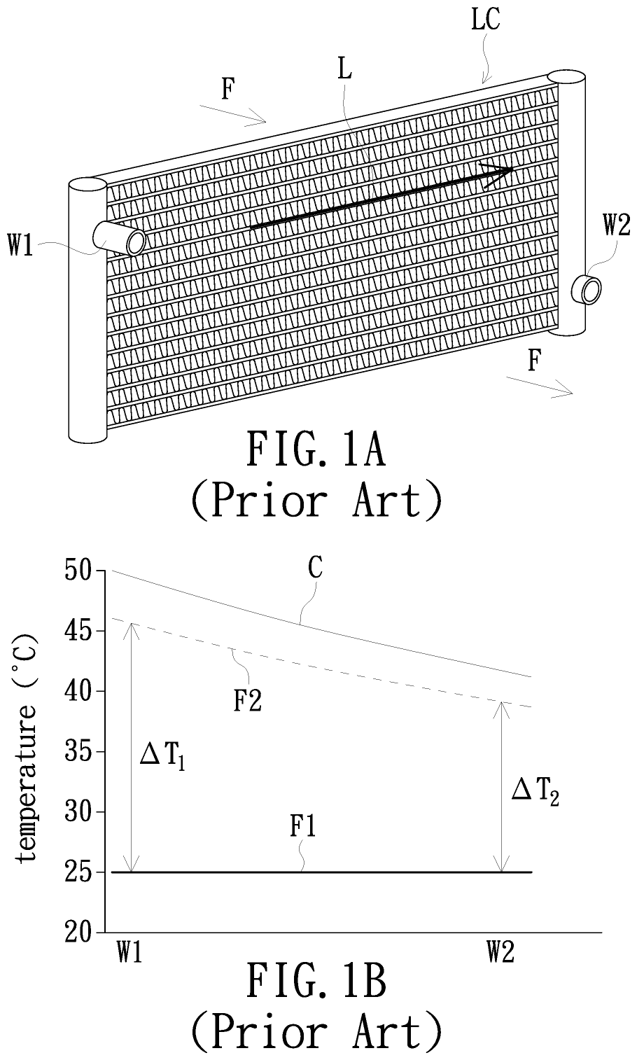

Please refer to FIG. 2 and FIG. 6 together. The temperature C2 of the liquid L in the second liquid cooling row 120 is lower than the temperature C1 of the liquid L in the first liquid cooling row 110, and the airflow F generated by the fan 130 sequentially cools the second liquid cooling row 120 and the first liquid cooling row 110. Therefore, the airflow F may cool the second liquid cooling row 120 having a lower liquid temperature C2 with a lower temperature T1. The temperature T1 of the airflow F increases to the temperature T2 after passing through the second liquid cooling row 120. After the airflow F passes through the second liquid cooling row 120, the airflow F may cool the first liquid cooling row 110 having a higher liquid temperature C1 with a higher temperature T2, so that the temperature T2 of the airflow F increases to a temperature T3 after passing through the first liquid cooling row 110. As shown in FIG. 6, the temperature difference between the temperatures T3 and T1 at the position W1 is ΔTI, and the temperature difference at the position WO is ΔTO. Compared with FIG. 1B (prior art), the temperature difference ΔTO of the present embodiment is significantly larger than ΔT2 of FIG. 1B. Therefore, the liquid cooling device 100 may effectively solve the problem of uneven heat dissipation.

Compared with the prior art, the liquid cooling device 100 of the present embodiment has the first liquid cooling row 110 and the second liquid cooling row 120 disposed opposite to each other. The liquid L sequentially flows through the first liquid cooling row 110 and the second liquid cooling row 120 in two opposite directions. Therefore, the temperature of the liquid L in the second liquid cooling row 120 is lower than the temperature of the liquid L in the first liquid cooling row 110. Since the airflow F generated by the fan 130 sequentially cools the second liquid cooling row 120 and the first liquid cooling row 110, the airflow F having lower temperature is used to cool the second liquid cooling row 120 having lower temperature when the airflow F flows through the second liquid cooling row 120, and the airflow F flowed through the second liquid cooling row 120 and increased its temperature is used to cool the first liquid cooling row 110 having higher temperature. Thus, the airflow F may maintain an appropriate temperature difference between each of the second liquid cooling row 120 and first liquid cooling row 110 when flowing through the second liquid cooling row 120 and the first liquid cooling row 110, thereby improving the heat exchange effect. In addition, the high temperature end (first inflow end 111) of the first liquid cooling row 110 is adjacent to the low temperature end (second outflow end 122) of the second liquid cooling row 120, and the low temperature end (first outflow end 112) of the first liquid cooling row 110 is adjacent to the high temperature end (second inflow end 121) of the second liquid cooling row 120. Thus, a part of the airflow F flowed through the low temperature end of the second liquid cooling row 120 flows through the high temperature end of the first liquid cooling row 110, and a part of the airflow F flowed through the high temperature end of the second liquid cooling row 120 flows through the low temperature end of the first liquid cooling row 110. Therefore, the overall temperature of the airflow F after sequentially flowing through the second liquid cooling row 120 and the first liquid cooling row 110 is more even, thereby improving the overall heat dissipation effect of the airflow F.

It is noted that the number of the liquid cooling rows in the present embodiment is not limited to two shown in FIG. 2. Other liquid cooling rows may be connected between the first liquid cooling row 110 and the second liquid cooling row 120. In an embodiment, the number of liquid cooling rows may also be an odd number, which makes the first inflow end 111 of the first liquid cooling row 110 and the second outflow end 122 of the second liquid cooling row 120 are located on two different sides of the liquid cooling device 100, thereby providing a more flexible configuration manner.

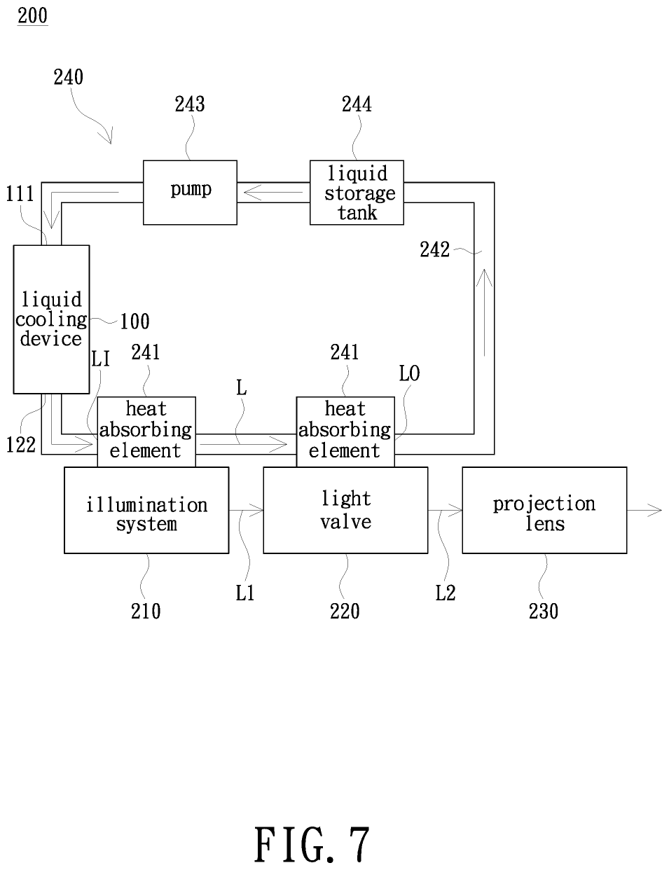

FIG. 7 is a schematic block diagram of a projection device according to an embodiment of the invention. Please refer to FIG. 7. A projection device 200 includes an illumination system 210, a light valve 220, a projection lens 230, and a cooling system 240. The illumination system 210 includes a light source 211. The light source 211 is adapted to provide an illumination beam L1. The light valve 220 is disposed on a transmission path of the illumination beam L1 to convert the illumination beam L1 into an image beam L2. The projection lens 230 is disposed on a transmission path of the image beam L2.

The aforementioned light source 211 may include a light emitting diode (LED), a laser diode (LD), or an ultra-high-pressure mercury lamp (UHP lamp), but is not limited thereto. The illumination beam L1 provided by the light source 211 is transmitted to the light valve 220 by other optical elements of the illumination system 210. The light valve 220 may be a digital micro-mirror device (DMD), a liquid crystal on silicon (LCOS) panel, or a liquid crystal display (LCD) panel, but it is not limited thereto. The present embodiment does not limit the number of the light valve 220. For example, the projection device 200 may adopt a structure of single-chip LCD panel or three-chip LCD panel, but it is not limited thereto. In addition, the projection lens 230 includes, for example, a combination of one or more optical lenses having diopter, such as various combinations of non-planar lenses including biconcave lenses, biconvex lenses, concavo-convex lenses, convexo-concave lenses, plano-convex lenses, and plano-concave lenses. On the other hand, the projection lens 230 may also include a flat optical lens. The invention does not limit the form and the type of the projection lens 230.

Since the components such as the aforementioned light source 211 and the light valve 220 are easily to generate a lot of waste heat, the cooling system 240 may be used to cool these components that are easily to generate a lot of waste heat. Specifically, the cooling system 240 includes the liquid cooling device 100 as mentioned previously, at least one heat absorbing element 241, and a liquid conveying pipeline 242. The at least one heat absorbing element 241 is connected to at least one of the light source 211 and the light valve 220. The number of heat absorbing element 241 may be determined by the number of components that easily generate a large amount of waste heat. Two heat absorbing elements 241 are shown as an example in FIG. 7, but not limited thereto. In the present embodiment, the heat absorbing element 241 is, for example, a cold plate, but it is not limited thereto. Each heat absorbing element 241 has a liquid inflow end and a liquid outflow end. The liquid inflow end may be used for liquid L to flow in, and the liquid outflow end may be used for the liquid L to flow out. In order to clearly illustrate the flowing direction of the liquid L in the cooling system 240, FIG. 7 only shows the liquid inflow end LI connected to the liquid cooling device 100 and the liquid outflow end LO connected to a liquid storage tank 244. The characteristics of the liquid storage tank 244 will be described in the following paragraphs. The liquid conveying pipeline 242 is connected in series with the heat absorbing element 241 and the liquid cooling device 100. The liquid L outflows from the second outflow end 122 flows into the heat absorbing element 241 through the liquid conveying pipeline 242 and the liquid inflow end LI, and flows into the first inflow end 111 through the liquid outflow end LO and the liquid conveying pipeline 242.

The cooling system 240 of the present embodiment may further include a pump 243 and the liquid storage tank 244. The liquid conveying pipeline 242 is also connected in series with the pump 243 and the liquid storage tank 244. The liquid storage tank 244 may store the liquid L to maintain the flow of the liquid L in the cooling system 240. The pump 243 is used to drive the liquid L to flow. The positions of the pump 243 and the liquid storage tank 244 in the cooling system 240 are not limited to the configuration shown in FIG. 7. Please refer to FIG. 2. In another embodiment, the pump 243 and the liquid storage tank 244 may be disposed at the pipeline connecting between the second header tank 116 and the third header tank 125. Thus, the liquid L flows through the second header tank 116, then flows through the pump 243 and the liquid storage tank 244, and then flows to the third header tank 125. In another embodiment, the pump 243 and the liquid storage tank 244 may also be disposed at the pipeline between the plurality of heat absorbing elements 241. The liquid L flows through the previous heat absorbing element 241, then flows through the pump 243 and the liquid storage tank 244, and then flows to the next heat absorbing element 241. The sequence of the liquid L flowing through the pump 243 and the liquid storage tank 244 in the invention may be designed according to actual conditions.

In the present embodiment, the pump 243 may drive the liquid L into the heat absorbing elements 241 connected to the light source 211 and the light valve 220 through the liquid inflow end LI, so that the liquid L exchanges heat with the heat absorbing elements 241. Then, the liquid L flows into the liquid conveying pipeline 242 through the liquid outflow end LO. The liquid L flowing out of the liquid outflow end LO is conveyed to the liquid cooling device 100 for cooling.

Since the liquid cooling device 100 used in the projection device 200 of the present embodiment has an even and good heat dissipation effect, the projection device 200 has good reliability.

In summary, the liquid cooling device used in the invention has a first liquid cooling row and a second liquid cooling row disposed opposite to each other, wherein the liquid sequentially flows through the first liquid cooling row and the second liquid cooling row in two opposite directions, so the temperature of the liquid in the second liquid cooling row may be lower than the temperature of the liquid in the first liquid cooling row. Since the airflow generated by the fan sequentially cools the second liquid cooling row and the first liquid cooling row, the airflow of lower temperature is used to cool the second liquid cooling row of lower temperature when the airflow flows through the second liquid cooling row. The heated airflow which flowed through the second liquid cooling row is used to cool the first liquid cooling row of higher temperature. Thus, when the airflow flows through the second liquid cooling row and the first liquid cooling row, the airflow may maintain a proper temperature difference from the second liquid cooling row and the first liquid cooling row, respectively, thereby improving the heat exchange effect. In addition, the high temperature end (first inflow end) of the first liquid cooling row is adjacent to the low temperature end (second outflow end) of the second liquid cooling row, and the low temperature end (first outflow end) of the first liquid cooling row is adjacent to the high temperature end (second inflow end) of the second liquid cooling row. Therefore, part of the airflow after flowing through the low temperature end of the second liquid cooling row may flow through the high temperature end of the first liquid cooling row, and part of the airflow after flowing through the high temperature end of the second liquid cooling row may flow through the low temperature end of the first liquid cooling row. Such that the overall temperature of the airflow after sequentially flowing through the second liquid cooling row and the first liquid cooling row may be more even, thereby improving the overall heat dissipation effect of the airflow. Also, since the projection device of the invention uses the aforementioned liquid cooling device, the projection device has good reliability.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first liquid cooling row, the second liquid cooling row, the first inflow end, the second inflow end, the first outflow end, the second outflow end, the first liquid cooling tube, the second liquid cooling tube, the first heat dissipating element, the second heat dissipating element, the first header tank, the second header tank, the third header tank, the fourth header tank, the first direction, and the second direction are only used for distinguishing various elements and do not limit the number of the elements.

What is claimed is:

1. A liquid cooling device, comprising: a first liquid cooling row, a second liquid cooling row, and a fan, wherein
the first liquid cooling row has a first inflow end and a first outflow end for liquid to flow from the first inflow end to the first outflow end in a first direction;
the second liquid cooling row is disposed opposite to the first liquid cooling row, the second liquid cooling row has a second inflow end and a second outflow end, the second inflow end is connected to the first outflow end for the liquid flowing out of the first outflow end to flow from the second inflow end to the second outflow end in a second direction, wherein the first direction is opposite to the second direction; and
the fan is adapted to generate airflow, and the airflow sequentially flows through the second liquid cooling row and the first liquid cooling row to cool the liquid.

2. The liquid cooling device according to claim 1, wherein the first liquid cooling row comprises a plurality of first liquid cooling tubes arranged at intervals, each of the plurality of first liquid cooling tubes extends in the first direction, the second liquid cooling row comprises a plurality of second liquid cooling tubes arranged at intervals, each of the plurality of second liquid cooling tubes extends in the second direction, and the plurality of first liquid cooling tubes are respectively opposite to the plurality of second liquid cooling tubes.

3. The liquid cooling device according to claim 2, wherein the first liquid cooling row further comprises a plurality of first heat dissipating elements connected between the plurality of first liquid cooling tubes, and the second liquid cooling row further comprises a plurality of second heat dissipating elements connected between the plurality of second liquid cooling tubes.

4. The liquid cooling device according to claim 3, wherein the plurality of first heat dissipating elements and the plurality of second heat dissipating elements comprise a plurality of heat dissipating fins.

5. The liquid cooling device according to claim 2, wherein the plurality of first liquid cooling tubes and the plurality of second liquid cooling tubes comprise a plurality of flat tubes.

6. The liquid cooling device according to claim 2, wherein
the first liquid cooling row further comprises a first header tank and a second header tank, the plurality of first liquid cooling tubes are connected between the first header tank and the second header tank, the first header tank has the first inflow end, and the second header tank has the first outflow end; and
the second liquid cooling row further comprises a third header tank and a fourth header tank, the plurality of second liquid cooling tubes are connected between the third header tank and the fourth header tank, the third header tank has the second inflow end, and the fourth header tank has the second outflow end.

7. The liquid cooling device according to claim 1, wherein the first liquid cooling row and the second liquid cooling row are separated by a predetermined distance.

8. The liquid cooling device according to claim 1, further comprising a liquid conduit, wherein the liquid conduit is connected between the first outflow end and the second inflow end.

9. A projection device, comprising: an illumination system, a light valve, a projection lens, and a cooling system, wherein the illumination system comprises a light source, the light source is adapted to provide an illumination beam, the light valve is disposed on a transmission path of the illumination beam to convert the illumination beam into an image beam, the projection lens is disposed on a transmission path of the image beam, and the cooling system comprises a liquid cooling device, at least one heat absorbing element, and a liquid conveying pipeline, wherein
the liquid cooling device comprises a first liquid cooling row, a second liquid cooling row, and a fan, wherein
the first liquid cooling row has a first inflow end and a first outflow end for liquid to flow from the first inflow end to the first outflow end in a first direction;
the second liquid cooling row is disposed opposite to the first liquid cooling row, the second liquid cooling row has a second inflow end and a second outflow end, and the second inflow end is connected to the first outflow end for the liquid flowing out of the first outflow end to flow from the second inflow end to the second outflow end in a second direction, wherein the first direction is opposite to the second direction; and
the fan is adapted to generate airflow, and the airflow sequentially flows through the second liquid cooling row and the first liquid cooling row to cool the liquid;
the at least one heat absorbing element is connected to at least one of the light source and the light valve, and the heat absorbing element has a liquid inflow end and a liquid outflow end; and
the liquid conveying pipeline is connected in series with the heat absorbing element and the liquid cooling device, wherein the liquid flowing out from the second outflow end flows into the heat absorbing element through the liquid conveying pipeline and the liquid inflow end and flows into the first inflow end through the liquid outflow end and the liquid conveying pipeline.

10. The projection device according to claim 9, wherein the cooling system further comprises a pump and a liquid storage tank, and the liquid conveying pipeline is also connected in series with the pump and the liquid storage tank.

11. The projection device according to claim 10, wherein the first liquid cooling row comprises a plurality of first liquid cooling tubes arranged at intervals, each of the plurality of first liquid cooling tubes extends in the first direction, the second liquid cooling row comprises a plurality of second liquid cooling tubes arranged at intervals, each of the plurality of second liquid cooling tubes extends in the second direction, and the plurality of first liquid cooling tubes are respectively opposite to the plurality of second liquid cooling tubes.

12. The projection device according to claim 11, wherein the first liquid cooling row further comprises a plurality of first heat dissipating elements connected between the plurality of first liquid cooling tubes, and the second liquid cooling row further comprises a plurality of second heat dissipating elements connected between the plurality of second liquid cooling tubes.

13. The projection device according to claim 12, wherein the plurality of first heat dissipating elements and the plurality of second heat dissipating elements comprise a plurality of heat dissipating fins.

14. The projection device according to claim 11, wherein the plurality of first liquid cooling tubes and the plurality of second liquid cooling tubes comprise a plurality of flat tubes.

15. The projection device according to claim 11, wherein
the first liquid cooling row further comprises a first header tank and a second header tank, the plurality of first liquid cooling tubes are connected between the first header tank and the second header tank, the first header tank has the first inflow end, and the second header tank has the first outflow end; and
the second liquid cooling row further comprises a third header tank and a fourth header tank, the plurality of second liquid cooling tubes are connected between the third header tank and the fourth header tank, the third header tank has the second inflow end, and the fourth header tank has the second outflow end.

16. The projection device according to claim 9, wherein the first liquid cooling row and the second liquid cooling row are separated by a predetermined distance.

17. The projection device according to claim 9, wherein the liquid cooling device further comprises a liquid conduit connected between the first outflow end and the second inflow end.
